(19) United States
(12) Patent Application Publication
(10) Pub. No.: US 2008/0297526 A1
(43) Pub. Date: Dec. 4, 2008

(54) METHOD FOR ENHANCING RENDERING PERFORMANCE OF NAVIGATION DEVICE

(75) Inventor: Min-Young SONG, Pyeongtaek-si (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/043,779

(22) Filed: Mar. 6, 2008

(30) Foreign Application Priority Data
Jun. 1, 2007 (KR) 10-2007-0053997

(51) Int. Cl. G09G 5/00

(52) U.S. Cl. 345/581

(57) ABSTRACT

A method for displaying map data on a screen of a navigation device. The method includes receiving a screen display request, rendering a particular interpolation point that is not within a filtering range among interpolation points included in the map data to be displayed on the screen and displaying the rendered interpolation point on the screen.

This nonprovisional application claims priority under 35 U.S.C. §119(a) to Patent Application No. 10-2007-0053997 filed in Republic of Korea on Jun. 1, 2007, the entire contents of which are hereby incorporated by reference.

### BACKGROUND OF THE INVENTION

1. Field of the Invention

The present invention relates to a navigation device and a method for enhancing rendering performance of a navigation device.

2. Description of the Related Art

In general, map data used to indicate a current location or to search a route in a navigation system is stored in a storage medium such as a CD-ROM (Compact Disc-Read Only Memory), an HDD (Hard Disk Drive), or the like, mounted in the navigation system and has a linear data format, an image data format, or the like.

In order to display such map data on a screen, longitude and latitude coordinate values of interpolation points of the map data are converted into screen coordinates, and then a rendering operation is performed. Thus, if there are many interpolation points, the processing rate and scroll speed of the device are delayed when displaying the map data on the screen. In addition, because the interpolation points are dense when zooming out, the performance of the device is degraded due to an unnecessary map scrolling operations.

### SUMMARY

Accordingly, one aspect of the present invention is to address the above-note and other objections.

An other aspect of present invention is to provide a navigation device capable of effectively displaying map data on a screen, and a method for enhancing a rendering performance of the navigation device.

To achieve these and other advantages and in accordance with the purpose of the present invention, as embodied and broadly described herein, the present invention provides in one aspect a method for displaying map data on a screen of a navigation device. The method includes receiving a screen display request, rendering a particular interpolation point that is not within a filtering range among interpolation pints included in the map data to be displayed on the screen, and displaying the rendered interpolation point on the screen.

In another aspect, the present invention provides a navigation device including an input unit configured to receive a screen display request, a control unit configured to render a particular interpolation point that is not within a filtering range among interpolation points included in map data to be displayed, and a display unit configured to display the rendered interpolation point.

Further scope of applicability of the present invention will become apparent from the detailed description given hereinafter. However, it should be understood that the detailed description and specific examples, while indicating preferred embodiment of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings, which are given by illustration only, and thus are not limitative of the present invention, and wherein:

FIG. 1 is a block diagram illustrating a navigation device according to an embodiment of the present invention;

FIG. 2 is a flow chart illustrating a screen display method of the navigation device according to an embodiment of the present invention;

FIG. 3 is an overview showing an example of detecting interpolation points within a filtering range by using difference values between relative coordinates of interpolation points according to one embodiment of the present invention;

FIG. 4 is an overview showing an example of detecting interpolation points within a filtering range by using an angle difference between interpolation points according to another embodiment of the present invention;

FIG. 5 is an overview showing an example of detecting interpolation points within a filtering range by using an area value between interpolation points according to yet another embodiment of the present invention;

FIG. 6 is an overview showing an example of a process of converting relative coordinates of interpolation points into absolute coordinates; and

FIG. 7 is a flow chart illustrating a method for enhancing a rendering performance of a navigation device according to an embodiment of the present invention.

### DETAILED DESCRIPTION OF THE INVENTION

Reference will now be made in detail to the preferred embodiments of the present invention, examples of which are illustrated in the accompanying drawings.

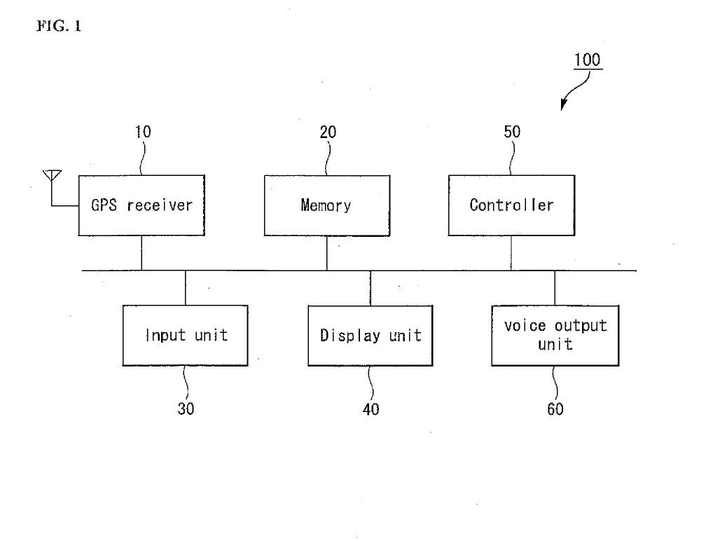

FIG. 1 is a block diagram illustrating a navigation device 100 according to an embodiment of the present invention. As shown, the navigation device 100 includes a GPS receiver 10, a memory 20, an input unit 30, a display unit 40, a controller 50, and a voice output unit 60.

The GPS receiver 10 is configured to receive GPS data, a location information signal transmitted by a GPS satellite (not shown) via an antenna ANT and to provide the GPS data to the controller 50. Further, the memory 20 stores an operational program, digital map data, and according to an embodiment of the present invention, the memory 20 also stores a currently set zoom scale level and a filtering range corresponding to the zoom scale level.

In addition, the input unit 30 receives various operational commands from a user and transmits the received commands to the controller 50. The input unit 20 also receives a screen image conversion request, a screen image scroll request, a zoom-in/zoom-out request, etc. from the user and provides the same input information to the controller 50. Further, the input unit 20 may be implemented as key buttons, a remote controller, a touch pad, a touch screen, or the like.

The display unit 40 displays the map stored in the memory 20 and a current location of a vehicle on the map under the control of the controller 50. In addition, the display unit 40 displays a travel route from a start point to a destination point under the control of the controller 50. In an embodiment of the present invention, the display unit 40 may also implemented as a touch screen, in which input commands may be entered by touching the touch screen.

Further, the controller 50 determines a current location of the vehicle based on an output signal of the GPS receiver 10 and matches the current location of the vehicle to the map. Also, when a screen image conversion request, screen image scroll reqest or zooming-in/zooming-out request is received through the input unit 30, the controller 50 checks a current zoom scale level with reference to the memory 20 and also checks whether or not interpolation points included in map data to be displayed on the display unit 40 are within a filtering range.

In addition, the controller 50 performs a rendering operation on interpolation points that are not within the filtering range and displays the rendered interpolation points on the display unit 40. Further, the controller 50 advantageously does not perform a rendering operation on interpolation points that are within the filtering range. The voice outputs unit 60 generates a voice guidance signal and output the voice guidance signal via a speaker (not shown) under the control of the controller 50.

As for the vehicle having the navigation device 100 with such a configuration, when the user inputs a start point and a destination point of the vehicle via the input unit 30 and requests a travel route be searched, the controller 50 searches a travel route of the vehicle from the start point to the destination point by using the map data stored in the memory 20 and displays the searched travel route on the display unit 40 so that the user can view and confirm the travel route.

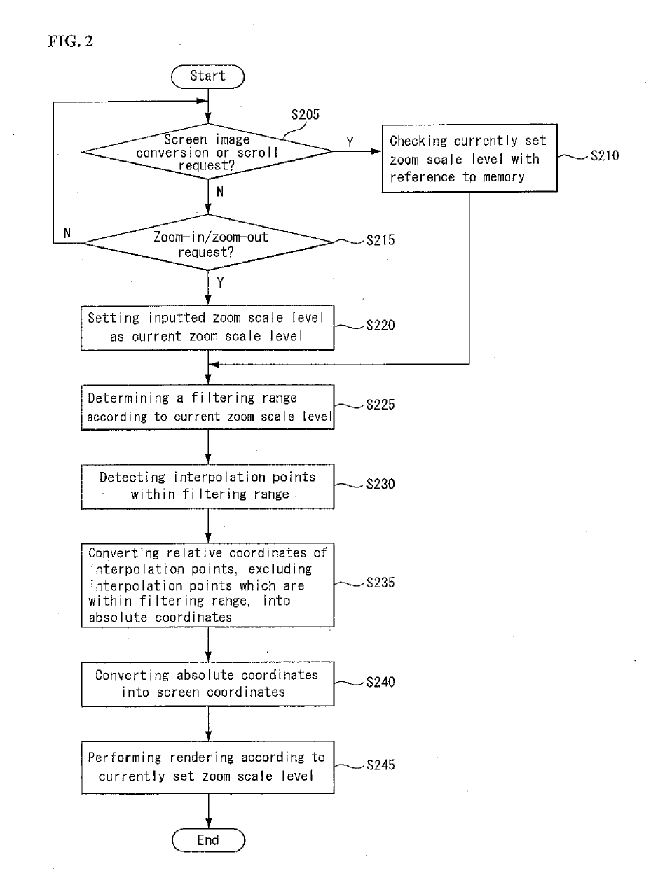

Next, FIG. 2 is a flow chart illustrating a screen display method of the navigation device according to one embodiment of the present invention. FIG. 1 will also be referred to in this description

With reference to FIG. 2, and assuming a map where the vehicle is currently located is displayed on the display unit 40 and a screen image conversion request or a screen image scroll request is received from the user (Yes in S205), the controller 50 checks a currently set zoom scale level with reference to the memory 20 (S210).

The zoom scale level may include seven phases or twelve phases. For example, if the zoom scale level includes a total of seven phases from a first phase to a seventh phase and a currently set zoom scale level is a second phase, the controller 50 determines that the currently set zoom scale level is the second phase with reference to the memory 20.

When the user inputs a zoom-in request for magnifying the map or inputs a zoom-out request for reducing the map through the input unit 30 (Yes in S215), the controller 50 checks a zoom scale level value inputted through the input unit 30 and updates the checked zoom scale level value in the memory 20 to set it as a current zoom scale level (S220).

After the current zoom scale level is checked, the controller 50 determines a filtering range corresponding to the currently set zoom scale level with reference to the memory 20 (S225). Further, the filtering range may be calculated to have an optimum value according to experimentation and be stored in the memory 20 such that the filtering range corresponds to the zoom scale level.

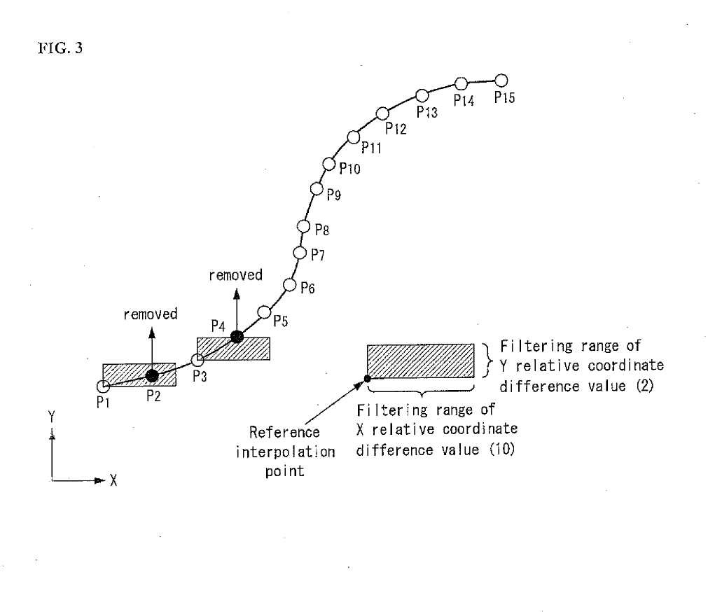

Then, the controller 50 detects interpolation points that come within the filtering range by using difference values between relative coordinates of interpolation points, an angle difference between interpolation points, an area value between interpolation points, or the like (S230) In more detail, FIG. 3 is an overview showing an example of detecting interpolation points within a filtering range by using difference values between relative coordinates of interpolation points according to one embodiment of the present invention.

With reference to FIG. 3, an example in which the current zoom scale level is the second phase and a corresponding filtering range is relative coordinates (10,2) is used. Specifically, the controller 50 determines an interpolation point that comes within a range not greater than 10 in the same direction as the X axis from a single reference interpolation point and comes within a range not greater than 2 in the same direction as the Y axis from the single reference interpolation point, as an interpolation point that is within the filtering range.

As shown in FIG. 3, the interpolation point P2 is within the filtering range. That is, the interpolation point P2 comes within the range not greater than 10 in the same direction as the X axis from a reference interpolation point P1 and comes within the range not greater than 2 in the same direction as the Y axis from the reference interpolation point P1. Accordingly, the interpolation point P2 comes within the filtering range based on the reference interpolation point P1.

Then, the controller 50 removes the interpolation point P2 within the filtering range, and determines a different interpolation point that may come within the filtering range in the same manner as described above by using the next interpolation point P3 as a reference interpolation point.

Namely, the controller 50 determines interpolation points that come within the range not greater than 10 in the same direction as the X axis from P3 used as the reference interpolation point and comes within the range not greater than 2 in the same direction as the Y axis from the reference interpolation point P3, as interpolation points that come within the filtering range, and removes such interpolation points that are within the filtering range.

In FIG. 3, the interpolation point P4 comes within the range not greater than 10 in the same direction as the X axis on the basis of the interpolation point P3 and comes within the range not greater than 2 in the same direction as the Y axis, and therefore is removed. Subsequently, the controller 50 performs the filtering process in the same manner as described above based on a next interpolation point P5, and the filtering process is performed on all the interpolation points to be displayed on the screen.

As mentioned above, this embodiment of the present invention employs the method in which different interpolation points that come within a certain range in the same direction as the X axis and in the same direction as the Y axis based on relative coordinates of a single reference interpolation point are determined as interpolation points that are within the filtering range.

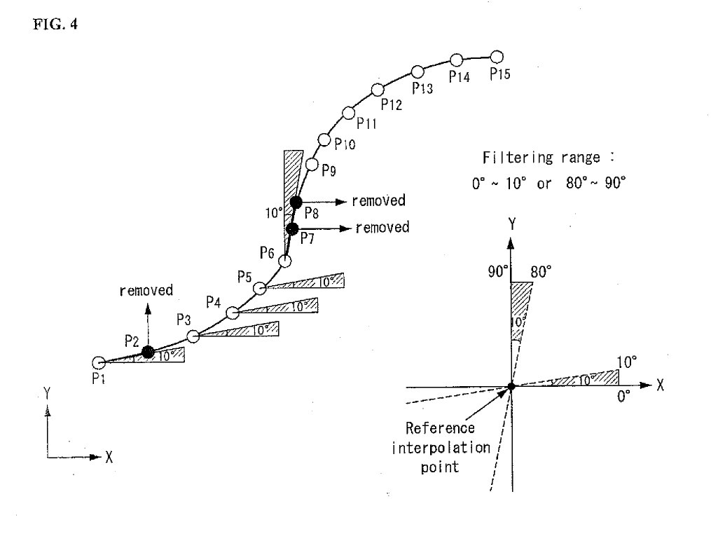

Next, FIG. 4 is an overview showing an example of detecting interpolation points within a filtering range by using an angle difference between interpolation points according to another embodiment of the present invention. As shown in FIG. 4, an example where a current zoom scale level is the second phase and a corresponding filtering range is determined to be at angle differences of 0° to 10° and 80° to 90.

In this example, the controller 50 filters interpolation points that come within ranges between angles, namely, within a range between 0° and 10° or within a range between 80° and 90° previously set based on an interpolation point included in map data to be displayed on the display unit 40.

In more detail, the controller So determines first different interpolation points that come within the range between 0° and 10° or between 80° and 90° based on the interpolation point P1. In FIG. 4, an interpolation point P2 is within the filtering range, namely, within the range between 0° and 10° or between 80° and 90° based on the reference interpolation point P1.

Thus, the controller 50 removes the interpolation point P2 that is within the filtering range, and performs the filtering process on the next interpolation point P3 in the same manner as described above. Further, in FIG. 4, because there is no interpolation point within the filtering range based on the reference interpolation point P3, the controller 50 searches interpolation points that may come within the filtering range based on the next interpolation point P4.

As shown in FIG. 4, there is also no interpolation point that comes within the filtering range when the interpolation points P4 and P5 are used as reference interpolation points, while interpolation points P7 and P8 come within the filtering range, namely, within the range between 80° and 90°, based on the reference interpolation point P6. Thus, the interpolation points P7 and P8 are filtered out, and the controller 50 performs the filtering process in the same manner as described above by using the next interpolation point P1. Further, the filtering process is performed on the interpolation points P1 to P15.

As described above, the present embodiment employs the method in which different interpolation points that come within a range of a certain angle from a reference interpolation point are filtered.

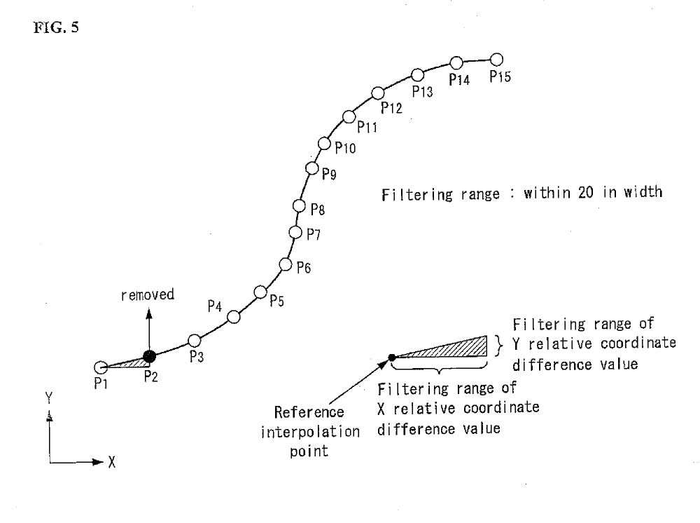

Next, FIG. 5 is an overview showing an example of detecting interpolation points within a filtering range by using an area value between interpolation points according to yet another embodiment of the present invention. With reference to FIG. 5, an example where a current zoom scale level is the second stage and a corresponding filtering range is an area value 20 is used.

In FIG. 5, the controller 50 sequentially calculates areas of right-angled triangles respectively formed by the interpolation point P1 and interpolation points P2 to P15 based on the interpolation point P1. In more detail, an area value of the right-angled triangle formed by the reference interpolation point P1 and the interpolation point P2 is first obtained as described in the following description. Further, each area value of the right-angled triangles formed by the reference interpolation point P1 with the other interpolation points can be obtained in the same manner as that of the right-angled triangle formed by the reference interpolation point P1 and the interpolation point P2.

If relative coordinate values of the reference interpolation point P1 are (X1,Y1) and relative coordinate values of the interpolation point P2 are (X2,Y2), the controller 50 calculates the area of the right-angled triangle in which a straight line connecting the reference interpolation point P1 and the interpolation point P2 is the hypotenuse, a difference value of the X coordinates (i.e., X2-X1) between the P1 and P2 is the first side, a difference value of the Y coordinates (i-e., Y2-Y1) between the P1 and P2 is the second side, and the first side and the second side meet at right angles.

In addition, when the relative coordinate values of the reference interpolation point P1 are (X1,Y1) and the relative coordinate values of the interpolation point P2 are (X2,Y2), the area of the right-angled triangle formed by the interpolation points P1 and P2 can be expressed by the following equation (1).

$$S = \frac{1}{2} s \vert X 2 - X 1 \vert s \vert Y 2 - Y 1 \vert \qquad ( Equation 1 )$$

In equation (1) ‘S’ indicates the area of the right-angled triangle formed by the interpolation points P1 and P2, and if ‘S’ is within the filtering range, namely, if ‘S’ is a value of 20 or smaller, the interpolation point P2 is determined to be within the filtering range. In this instance, the controller 50 filters out the interpolation point P2. Further, the controller 50 repeatedly performs the same process on the other interpolation points by using the interpolation point P1 as a reference to detect interpolation points that are within the filtering range.

In this present embodiment, after the filtering process is performed based on the interpolation point P1, and if only the interpolation point P2 is within the filtering range, the controller 50 removes the interpolation point P2. Namely, based on the next interpolation point P3, the controller 50 calculates area values of the right-angled triangles formed by the reference interpolation point P3 and the interpolation points P4 to P15 and detects filtered interpolation points.

That is, the filtering process is performed on the interpolation points P1 to P15. Thus, in the present embodiment, the filtered interpolation points are detected by using the area values formed by the interpolation points. Further, as described above, an area of the right-angled triangle formed by a single particular interpolation point and another interpolation point based on the single particular interpolation point is calculated, and interpolation points of the calculated area coming within the filtering range are determined as interpolation points to be filtered out.

However, the present invention is not limited thereto, and an area of a rectangle formed by a particular interpolation point and a different interpolation point based on the particular interpolation point may be calculated, and if the calculated area corresponds to below a pre-set threshold value, the different interpolation point may be determined to be within the filtering range. In this instance, the pre-set threshold value may be selected according to a zoom scale level.

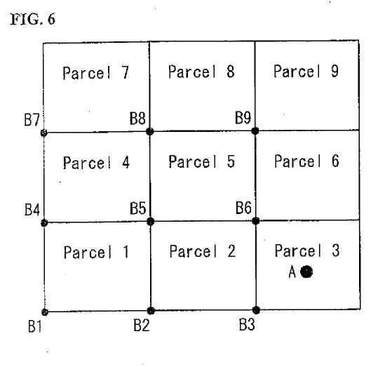

In addition, and with reference to FIG. 2, when the interpolation points within the filtering range are detected in the manner as described above with reference to FIGS. 3 to 5, the controller 50 converts the other remaining interpolation points, excluding the interpolation points that come within the filtering range, namely, the relative coordinates of the interpolation points to be eventually displayed on the display unit 40 into absolute coordinates (S235). In more detail, FIG. 6 is an overview showing an example of a process of converting the relative coordinates of interpolation points into the absolute coordinates.

With reference to FIG. 6, the map data in this example includes rectangular basic units of parcels. Further, each interpolation point in the map data is expressed as relative coordinate values based on a lower end of a left side of each parcel. Namely, the relative coordinates refer to coordinate values normalized based on the parcels.

In addition, because the map data includes several parcels, interpolation points belonging to mutually different parcels may have the same relative coordinate values. Thus, in order for relative coordinate values of each pixel to be actually displayed, the interpolation points need to be converted into actual unique absolute coordinates. The absolute coordinates refer to actual longitude and latitude coordinate values in a real distance.

In FIG, 6, the left lower ends of the respective parcels B1 to B9 refer to absolute coordinates. Absolute coordinates of an interpolation point ‘A’ in the parcel 3 can be expressed as the sum of the reference absolute coordinate B3 of the parcel 3 and coordinates normalized based on the left lower end point of the parcel 3.

Namely, the absolute coordinate values of an interpolation point belonging to a particular parcel may be expressed as the sum of the reference absolute coordinate of the parcel to which the interpolation point belongs and the coordinates normalized based on the left lower end point of the corresponding parcel. In this instance, the coordinates normalized based on the left lower end point of the corresponding parcel is calculated by multiplying relative coordinate values of the corresponding interpolation point and a normalized ratio of the map data.

Further, and with reference to FIG. 2, when the relative coordinate values of the interpolation points to be displayed on the display unit 40 are converted into the absolute coordinate values in such a manner as described above, the controller 50 converts the absolute coordinate values into screen coordinates on the basis of a reference point of the screen (S240).

In this instance, the conversion into the screen coordinates may be performed through a movement conversion, a reduction conversion and a rotation conversion. The screen coordinates are coordinate values by pixels based on an upper left point of a displayed region. After the conversion into the screen coordinates is performed, the controller 50 performs a rendering operation according to a currently set zoom scale level to display the map data on the display unit 40 (S245).

In the above-described embodiment of the present invention, the relative coordinates of all the interpolation points included in the map data to be displayed on the display unit 40 are not sequentially converted into the absolute coordinates and then into the screen coordinates and the rendering operation is then performed thereon, but that only the relative coordinates of the interpolation points which are not within the filtering ranges are sequentially converted into the absolute coordinates and then into the screen coordinates and the rendering operation is then performed thereon. Thus, the number of interpolation points to be rendered is reduced.

Therefore, when the map data is scrolled on the display unit 40, the phenomenon that a screen image is broken (discontinued or interrupted) is reduced, and the rate at which the map data is displayed on the display unit 40 in a zooming in or zooming out operation is improved. Further, after the interpolation points that come within the filtering ranges are detected based on the relative coordinates of the interpolation points included in the map data to be displayed on the display unit 40, the relative coordinates of the interpolation points, excluding the interpolation points that are within the filtering ranges, are sequentially converted into the absolute coordinates and then to the screen coordinates, and the rendering operation is then performed thereon.

However, the present invention is not limited thereto. That is, the relative coordinates of the interpolation points included in map data to be displayed on the display unit 40 may be first converted into absolute coordinates, interpolation points which come within a filtering range may be detected based on the absolute coordinates of the interpolation points, the absolute coordinates of the interpolation points excluding the interpolation points that are within the filtering range may be converted into the screen coordinates, and then, a rendering operation may be performed thereon.

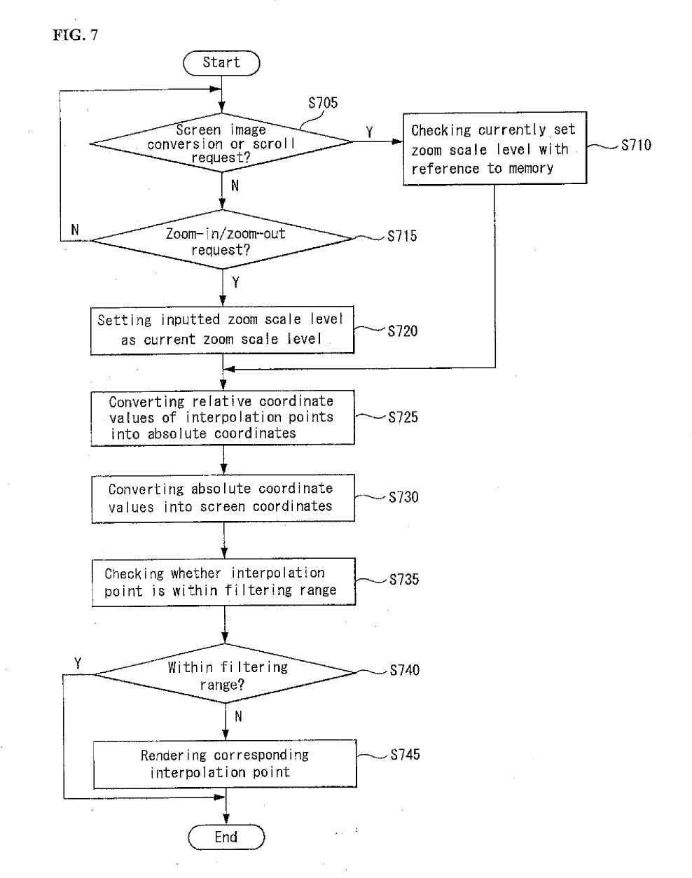

Next, FIG. 7 is a flow chart illustrating a method for enhancing a rendering performance of a navigation device according to another embodiment of the present invention. FIG. 1 will also be referred to in this description.

With reference to FIG. 7, when a screen image conversion request or a screen image scroll request is received from the user in a state that a map of an area where the vehicle is currently located is displayed (Yes in S705), the controller 50 checks a currently set zoom scale level with reference to the memory 20 (S710).

As previously discussed, the zoom scale level typically includes seven or twelve phases. For instance, if the zoom scale level includes a total of seven phases from a first phase to a seventh phase and a currently set zoom scale level is a second phase, the controller 50 determines that the currently set zoom scale level is the second phase with reference to the memory 20.

In addition, when the user inputs a zoom-in request for magnifying the map or inputs a zoom-out request for reducing the map through the input unit 30 (Yes in S715), the controller 50 checks a zoom scale level value inputted through the input unit 30 and updates the checked zoom scale level value in the memory 20 to set it as a current zoom scale level (S720).

After the current zoom scale level is checked, the controller 50 converts relative coordinates of interpolation points included in the map data into absolute coordinates (S725). The process of converting the relative coordinates into the absolute coordinates is the same as the process described above with reference to FIG. 6.

After the conversion into the absolute coordinates, the controller 50 converts the absolute coordinates of the interpolation points into screen coordinates (S730). The screen coordinates refer to the coordinate values by pixels based on the upper left point of a displayed region, and the conversion from the absolute coordinates into the screen coordinates is performed through a movement conversion, reduction conversion, and the rotation conversion likewise as described above.

In addition, the below Table 1 shows examples of screen coordinate values for a total of nine interpolation points, i.e., from an interpolation point Pi to an interpolation point P9, which exist on a region to be displayed on the screen and when a currently set zoom scale level is of the phase 2.

TABLE 1

| | |
|---|---|
| P1 | (−110, 16) |
| P2 | (−111, 26) |
| P3 | (−112, 30) |
| P4 | (−117, 39) |
| P5 | (−118, 45) |
| P6 | (−119, 49) |
| P7 | (−122, 128) |
| P8 | (−121, 136) |
| P9 | (−121, 138) |

In Table 1, the interpolation points P1 to P9 indicate the total of nine interpolation points from the first to the ninth interpolations, and the right numerical figures in parentheses indicate screen coordinate values of the interpolation points.

The below Table 2 shows the respective interpolation points and difference values between screen coordinates of the respective interpolation points and those of previous interpolation points of the corresponding interpolation points.

TABLE 2

| | Difference values between |
|---|---|
| | screen coordinates of the |
| | corresponding interpolations |
| | and those of previous |
| Interpolation points | interpolation points |
| P1 | X |
| P2 | (1, 10) |
| P3 | (1, 4) |
| P4 | (5, 69) |
| P5 | (1, 84) |
| P6 | (1, 94) |
| P7 | (3, 177) |
| P8 | (7, 58) |
| P9 | (0, 1) |

In Table 2, because the interpolation point P1 does not have a previous interpolation point, there is no difference value between the screen coordinates. Further, the difference values between the screen coordinates of the interpolation point P2 and those of its previous interpolation point P1 at the interpolation point P2 is calculated as a value of P2−P1, and the difference values between the screen coordinates of the interpolation point P3 and those of its previous interpolation point P2 at the interpolation point P3 is calculated as P3−P2.

With reference to FIG. 7, the controller 50 checks whether or not the difference values between the screen coordinates of the corresponding interpolation points and those of their previous interpolation points are within a pre-set coordinate range to determine whether or not the corresponding interpolation points are within the filtering range (S735).

In more detail, if the pre-set coordinate range is (2,10), the interpolation points whose difference values of the screen coordinates from their previous interpolation points are within the pre-set coordinate range (2,10) correspond to the interpolation points P2, P3 and P9. Namely, the controller 50 determines that the interpolation points, whose difference values of screen coordinates from their previous interpolation points are within the pre-set coordinate range, are within the filtering range.

The controller 50 then sequentially checks whether or not the interpolation points P1 to P9 are within the filtering range. If some interpolation points are not within the filtering points (No in S740), the controller 50 renders the corresponding interpolation points and displays the rendered interpolation points on the display unit 40 (S745) Meanwhile, the controller 50 does not perform a rendering operation on interpolation points that come within the filtering range, and moves to the next interpolation point.

Namely, in the present embodiment, the controller 50 renders the interpolation point P1 to display it, skipping over the interpolation points P2 and P3 that are within the filtering range, and then sequentially renders the interpolation points P4 to P8 that are not within the filtering range to display them on the display unit 40. In addition, because the final interpolation point P1 comes within the filtering range, the rendering operation is not performed thereon.

In the embodiment of the present invention, because the rendering operation is performed not on all of the interpolation points, but on the interpolation points that are not within the filtering range, the rendering performance in the navigation system is improved. Accordingly, the screen image discontinuation phenomenon is prevented during screen image scrolling, and the performance of displaying the map data during the zooming in or zooming out operation or when a screen image is changed is improved.

In the present embodiment as described above, the difference values of the screen coordinates are used to determine whether or not the interpolation points are within the filtering range, but the present invention is not limited thereto. That is, the interpolation points that come within the filtering range may be detected by using an angle difference or an area value between the interpolation points whose absolute coordinates have been converted into screen coordinates, or the like.

As described above, according to the embodiments of the present invention, when the map data is displayed on the screen, its processing rate or scroll speed is improved, and thus, the rendering performance of the navigation device is enhanced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for displaying map data on a screen of a navigation device, the method comprising:
receiving a screen display request;
rendering a particular interpolation point that is not within a filtering range among interpolation points included in the map data to be displayed on the screen; and
displaying the rendered interpolation point on the screen.

2. The method of claim 1, further comprising:
checking a current zoom scale level stored in a memory of the navigation device and a filtering range corresponding to the current zoom scale level, when the screen display request is a screen conversion request or a screen image scroll request; and
determining whether or not the particular interpolation point is within the filtering range corresponding to the current zoom scale level.

3. The method of claim 2, wherein the determining step determines whether the particular interpolation point is within the filtering range based on relative coordinate values of an interpolation point included in the map data,
wherein the method further comprises converting-relative coordinate values of the particular interpolation point are not within the filtering range into absolute coordinate values, and converting the absolute coordinate values into screen coordinate values,
wherein the rendering step renders the particular interpolation point that is not within the filtering range according to the current zoom scale level,
wherein the displaying step displays the rendered interpolation point on the screen, and
wherein the method further comprises removing an interpolation point that is within the filtering range.

4. The method of claim 1, further comprising:
checking a current zoom scale level inputted through an input unit and a filtering range corresponding to the current zoom scale level, if the screen display request is a zoom-in request or a zoom-out request; and
determining whether or not the particular interpolation point is within the filtering range corresponding to the current zoom scale level.

5. The method of claim 4, wherein the determining step determines whether the particular interpolation point is within the filtering range based on relative coordinate values of an interpolation point included in the map data,
wherein the method further comprises converting relative coordinate values of the particular interpolation point not within the filtering range into absolute coordinate values, and converting the absolute coordinate values into screen coordinate values,
wherein the rendering step renders the particular interpolation point that is not within the filtering range according to the current zoom scale level,
wherein the displaying step displays the rendered interpolation point on the screen, and
wherein the method further comprises removing an interpolation point that is within the filtering range.

6. The method of claim 5, wherein the determining step further comprises checking whether difference values between relative coordinates of one interpolation point and those of another interpolation point are within a certain coordinate range, and if the difference values are within the certain coordinate range, determining that said another interpolation point is within the filtering range.

7. The method of claim 5, wherein the determining step determines an interpolation point which comes within a certain angle range from a single interpolation point to be within the filtering range.

8. The method of claim 5, wherein the determining step determines when an area value of a particular region formed between one interpolation point and said another interpolation point is smaller than a pre-set area value,

9. The method of claim 1, further comprising:
checking whether the particular interpolation point is within the filtering range,
wherein the rendering step renders the particular interpolation point according to a currently set zoom scale level if the particular interpolation point is not within the filtering range.

10. The method of claim 9, further comprising:
converting relative coordinate values of the interpolation point included in the map data into absolute coordinate values and converting the absolute coordinate values into screen coordinate values; and
determining whether or not the particular interpolation point is within the filtering range based on the screen coordinate values of the particular interpolation point.

11. The method of claim 9, further comprising:
checking whether difference values between screen coordinates of a single interpolation point and those of a different interpolation point are within certain coordinate ranges,
wherein the determining step determines that the different interpolation point is within the filtering range when the difference values are within the certain coordinate ranges.

12. The method of claim 9, further comprising:
determining an interpolation point, which comes within a certain angle range from a single interpolation point whose absolute coordinate values have been converted into screen coordinate values, to be within the filtering range.

13. The method of claim 9, further comprising:
determining a different interpolation point is within the filtering range, if an area value of a particular region formed between a single interpolation point and the different interpolation point, whose respective absolute coordinate values have been converted into the screen coordinate values, is smaller than a pre-set area value.

14. The method of claim 9, wherein the checking step checks whether or not the particular interpolation point is within the filtering range based on relative coordinate values of the interpolation point included in the map data, and
wherein relative coordinate values of an interpolation point, which is not within the filtering range, are converted into absolute coordinate values, the absolute coordinate values are converted into screen coordinate values, and rendering is performed on a corresponding interpolation point to display the rendered interpolation point on the screen.

15. The method of claim 9, further comprising:
converting the relative coordinate values of the interpolation point included in the map data into the absolute coordinate values,
wherein the checking step checks whether or not the particular interpolation point is within the filtering range based on the interpolation point whose relative coordinate values have been converted into the absolute coordinate values.

16. A navigation device, comprising:
an input unit configured to receive a screen display request;
a control unit configured to render a particular interpolation point that is not within a filtering range among interpolation points included in map data to be displayed; and
a display unit configured to display the rendered interpolation point.

17. The navigation device of claim 16, wherein the control unit is further configured to check a current zoom scale level stored in a memory of the navigation device and a filtering range corresponding to the current zoom scale level, when the screen display request is a screen conversion request or a screen image scroll request, and to determine whether or not the particular interpolation point is within the filtering range corresponding to the current zoom scale level.

18. The navigation device of claim 17, wherein the control unit is further configured to determine whether the particular interpolation point is within the filtering range based on relative coordinate values of an interpolation point included in the map data, to convert relative coordinate values of the particular interpolation point not within the filtering range into absolute coordinate values, to convert the absolute coordinate values into screen coordinate values, to render the particular interpolation point that is not within the filtering range according to the current zoom scale level, and to remove an interpolation point that is within the filtering range, and
wherein the display unit displays the rendered interpolation point.

19. The navigation device of claim 17, wherein the control unit is further configured to check a current zoom scale level inputted through the input unit and a filtering range corresponding to the current zoom scale level, if the screen display request is a zoom-in request or a zoom-out request, and to determine whether or not the particular interpolation point is within the filtering range corresponding to the current zoom scale level.

20. The navigation device of claim 19, wherein the control unit is further configured to determine whether the particular interpolation point is within the filtering range based on relative coordinate values of an interpolation point included in the map data, to convert relative coordinate values of the particular interpolation point not within the filtering range into absolute coordinate values, to convert the absolute coordinate values into screen coordinate values, to render the particular interpolation point that is not within the filtering range according to the current zoom scale level, and to remove an interpolation point that is within the filtering range, and
wherein the display unit displays the rendered interpolation point.

21. The navigation device of claim 20, wherein the control unit is further configured to check whether difference values between relative coordinates of one interpolation point and those of another interpolation point are within a certain coordinate range, and if the difference values are within the certain coordinate range, to determine that said another interpolation point is within the filtering range.

22. The navigation device of claim 20, wherein the control unit is further configured to determine an interpolation point which comes within a certain angle range from a single interpolation point to be within the filtering range.

23. The navigation device of claim 20, wherein the control unit is further configured to determine when an area value of a particular region formed between one interpolation point and said another interpolation point is smaller than a pre-set area value.

24. The navigation device of claim 16, wherein the control unit is further configured to check whether the particular interpolation point is within the filtering range, and to render the particular interpolation point according to a currently set zoom scale level if the particular interpolation point is not within the filtering range.

25. The navigation device of claim 24, wherein the control unit is further configured to convert relative coordinate values of the interpolation point included in the map data into absolute coordinate values, to convert the absolute coordinate values into screen coordinate values, and to determine whether or not the particular interpolation point is within the filtering range based on the screen coordinate values of the particular interpolation point.

26. The navigation device of claim 24, wherein the control unit is further configured to check whether difference values between screen coordinates of a single interpolation point and those of a different interpolation point are within a certain coordinate ranges, and to determine that the different interpolation point is within the filtering range when the difference values are within the certain coordinate ranges.

27. The navigation device of claim 24, wherein the control unit is further configured to determine an interpolation point, which comes within a certain angle range from a single interpolation point whose absolute coordinate values have been converted into screen coordinate values, to be within the filtering range.

28. The navigation device of claim 24, wherein the control unit is further configured to determine a different interpolation point is within the filtering range, if an area value of a particular region formed between a single interpolation point and the different interpolation point, whose respective absolute coordinate values have been converted into the screen coordinate values, is smaller than a pre-set area value.

29. The navigation device of claim 24, wherein the control unit is further configured to check whether or not the particular interpolation point is within the filtering range based on relative coordinate values of the interpolation point included in the map data, and
wherein relative coordinate values of an interpolation point, which is not within the filtering range, are converted into absolute coordinate values, the absolute coordinate values are converted into screen coordinate values, and rendering is performed on a corresponding interpolation point to display the rendered interpolation point on the screen.

30. The navigation device of claim 24, wherein the control unit is further configured to convert the relative coordinate values of the interpolation point included in the map data into the absolute coordinate values, and to check whether or not the particular interpolation point is within the filtering range based on the interpolation point whose relative coordinate values have been converted into the absolute coordinate values.

31. The navigation device of claim 16, wherein the input unit comprises a touch screen.
